(19) United States
(12) Patent Application Publication
(10) Pub. No.: US 2014/0152691 A1
(43) Pub. Date: Jun. 5, 2014

(54) ELECTRONIC DEVICE AND METHOD FOR PROCESSING HANDWRITTEN DOCUMENT

(71) Applicant: KABUSHIKI KAISHA TOSHIBA, Tokyo (JP)

(72) Inventor: Yasuhiro OOKAWARA, Kunitachi-shi (JP)

(73) Assignee: KABUSHIKI KAISHA TOSHIBA, Tokyo (JP)

(21) Appl. No.: 13/768,132

(22) Filed: Feb. 15, 2013

(30) Foreign Application Priority Data
Nov. 30, 2012 (JP) 2012-262418

(51) Int. Cl. G06K 9/00

(52) U.S. Cl. CPC G06K 9/00865
USPC 345/619

(57) ABSTRACT

According to one embodiment, an electronic device includes a display controller, and a processor. The display controller displays a locus corresponding to a stroke. The processor performs one of processing of deleting a part of a first locus or processing of deleting all of the first locus, based on a vertical width and a horizontal width which correspond to the first locus.

### CROSS-REFERENCE TO RELATED APPLICATIONS

This application is based upon and claims the benefit of priority from Japanese Patent Application No. 2012-262418, filed Nov. 30, 2012, the entire contents of which are incorporated herein by reference.

### FIELD

Embodiments described herein relate generally to handwritten document processing.

### BACKGROUND

In recent years, various electronic devices, such as tablets, PDAs, and smartphones, have been developed. Most of such kinds of electronic devices include a touch screen display to facilitate an input operation by the user.

A locus corresponding to plural handwritten strokes input to the touch screen display is displayed on a touch screen.

When deleting the locus displayed on the touch screen, deleting per stroke is proposed in order to shorten time to deleting.

However, the alphabetic character of cursive script is continuously written with 1 stroke. In this case, it rewrites, when all characters will be deleted continuously and it will rewrite, if it deletes per 1 stroke, and a character increases, and it is inconvenient. Then, to delete efficiently the locus displayed on the display by which the input by hand writing was carried out is desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an appearance of an electronic device according to an embodiment.

FIG. 2 is an exemplary view illustrating an example of a handwritten document written by hand on a touch screen display of the electronic device of the embodiment.

FIG. 3 is an exemplary view illustrating time-series information, which is stored in a storage medium by the electronic device of the embodiment and corresponds to the handwritten document in FIG. 2.

FIG. 4 is an exemplary block diagram illustrating a system configuration of the electronic device of the embodiment.

FIG. 5 is an exemplary block diagram is a block diagram illustrating a functional configuration of a digital notebook application program executed by the electronic device of the embodiment.

FIG. 6 is an exemplary view illustrating an example of an interface.

FIG. 7 is an exemplary view illustrating an example of a handwritten page drawn by a handwritten document drawing processor.

FIG. 8 is an exemplary view illustrating an example of the handwritten page displayed on an LCD.

FIG. 9 is an exemplary view illustrating a handwritten character “A”.

FIG. 10 is an exemplary view illustrating a locus “ [symbol] ” in the block handwritten character “A”.

FIG. 11 is an exemplary view illustrating handwritten characters “a b c d e f g”.

FIG. 12 is an exemplary view illustrating the cursive handwritten characters “a b c d e f g”.

FIG. 13 is an exemplary view illustrating a locus of the handwritten characters “a b c d e f g”.

FIG. 14 is view illustrating a state in which, for example, the locus “ [symbol] ” in the block handwritten character “A” is selected.

FIG. 15 is a view illustrating a state in which, for example, the locus “ [symbol] ” is deleted from the block handwritten character “A”.

FIG. 16 is an exemplary view illustrating a state in which the locus of the consecutive cursive alphabetical characters “a b c d e f g” is selected.

FIG. 17 is an exemplary view illustrating a state in which the locus of the alphabetical characters “a b c d e f g” is partially deleted.

FIG. 18 is an exemplary view illustrating a handwritten arrow.

FIG. 19 is an exemplary view illustrating a state in which the locus of the handwritten arrow is deleted.

### DETAILED DESCRIPTION

Various embodiments will be described hereinafter with reference to the accompanying drawings.

In general, according to one embodiment, an electronic device includes a display controller, and a processor. The display controller is configured to display a locus corresponding to a stroke. The processor is configured to perform one of processing of deleting a part of a first locus or processing of deleting all of the first locus, based on a vertical width and a horizontal width which correspond to the first locus.

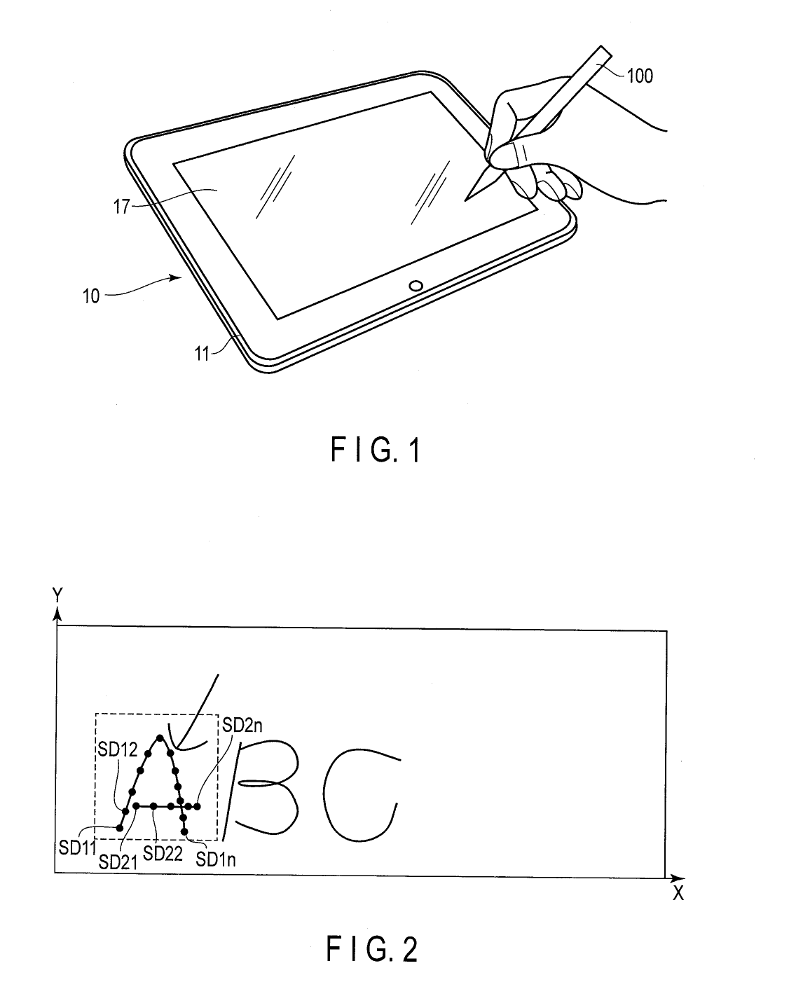

FIG. 1 is a perspective view showing an appearance of a tablet computer 10 according to an embodiment. The tablet computer 10 is a mobile electronic device that is also called a tablet or a slate computer. The tablet computer 10 includes a main body 11 and a touch screen display 17 as illustrated in FIG. 1. The touch screen display 17 is mounted so as to overlap with a top surface of the main body 11.

The main body 11 has a thin box casing. A flat panel display and a sensor configured to detect a contact position of a pen or a finger on the screen of the flat panel display are incorporated in the touch screen display 17. For example, the flat panel display may be a liquid crystal display (LCD). For example, an electrical capacitance touch panel or electromagnetic induction type digitizer can be used as a sensor. In the following description, it is assumed that two sensors of a digitizer and a touch panel are incorporated into the touch screen display 17.

Each of the digitizer and touch panel is provided so as to cover the screen of the flat panel display. The touch screen display 17 can detect not only a touch operation on the screen using the finger, but also a touch operation on the screen using a pen 100. For example, the pen 100 may be an electromagnetic induction pen. The user can perform a handwritten input operation on the touch screen display 17 using an external object (the pen 100 or the finger). A locus of movement of the external object (the pen 100 or the finger) on the screen, namely, a locus (handwriting) of a stroke written by a hand through a handwritten input operation is drawn in real time during the handwritten input operation, whereby the locus of each stroke is displayed on the screen. The locus of the movement of the external object during contact of the external object with the screen corresponds to a stroke. A set of many strokes corresponding to handwritten characters or figures, namely, a set of many trajectories (handwriting) constitutes a handwritten document.

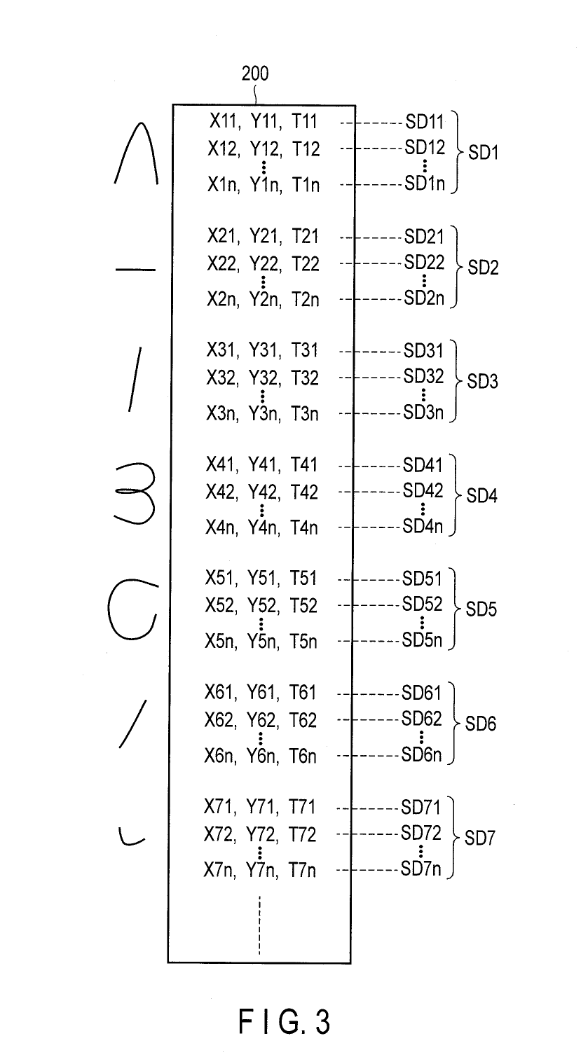

In the embodiment, the handwritten document is stored in a storage medium as not image data but a coordinate series of the trajectories of the strokes and time-series information indicating an order relationship between strokes. The time-series information will be described in detail later with reference to FIG. 3. The time-series information generally means a set of pieces of time-series stroke data corresponding to the plural strokes. Each piece of stroke data corresponds to a certain stroke and includes a coordinate data series (time series coordinates) corresponding to each point on the locus of the stroke. The sequence of the pieces of stroke data corresponds to the order in which each stroke is written by hand, namely, the order of strokes in handwriting.

The tablet computer 10 can read any piece of existing time-series information from the storage medium, and display the handwritten document corresponding to the time-series information, namely, the locus corresponding to each of the strokes indicated by the time-series information on the screen.

In the embodiment, the time-series information (the handwritten document data) may be managed as one or plural pages. In this case, the time-series information (the handwritten document data) may be split in area units that falls within a screen to record a chunk of time-series information that falls within a screen as a page. Alternatively, the page size may be variable. In this case, because the page size can be widened to an area larger than a screen size, the handwritten document having the area larger than the screen size can be dealt with as a page. When a whole of a page cannot simultaneously be displayed on the display, the page may be reduced or a display target portion of the page may be moved by vertical and horizontal scrolling.

The relationship between the stroke (such as a character, a mark, and a figure) handwritten by a user and the time-series information will be described below with reference to FIGS. 2 and 3. FIG. 3 illustrates an example of the handwritten document (a handwritten character string) that is handwritten on the touch screen display 17 using the pen 100.

In the handwritten document, frequently another character or another figure is handwritten on an already-handwritten character or figure. In FIG. 2, it is assumed that a handwritten character string “ABC” is handwritten in the order of “A”, “B”, and “C” and then an arrow is handwritten close to the handwritten character “A”.

The handwritten character “A” is expressed by two strokes (the locus of a “ [symbol] ” shape and the locus of a “-” shape) handwritten using the pen 100, namely, by the two trajectories. The locus of the “ [symbol] ” shape handwritten at first with the pen 100 is sampled in real time, for example, at equal intervals, thereby obtaining time series coordinates SD11, SD12, . . . , SD1n of strokes having the “ [symbol] ” shape. Similarly, the locus of the “-” shape handwritten with the pen 100 is sampled, thereby obtaining time series coordinates SD21, SD22, . . . , SD2n of strokes having the “-” shape.

The handwritten character “B” is expressed by the two strokes handwritten using the pen 100, namely, by the two trajectories. The handwritten character “C” is expressed by the stroke handwritten with the pen 100, namely, by the locus. The handwritten “arrow” is expressed by the two strokes handwritten with the pen 100, namely, by the two trajectories.

FIG. 3 illustrates time-series information 200 corresponding to the handwritten document in FIG. 2. The time-series information contains plural pieces of stroke data SD1, SD2, . . . , SD7. In the time-series information 200, the pieces of stroke data SD1, SD2, . . . , SD7 are arranged in time series in the order of handwriting, namely, in the order in which the strokes are handwritten.

In the time-series information 200, the first two pieces of stroke data SD1 and SD2 indicate two strokes of the handwritten character “A”. The third and fourth pieces of stroke data SD3 and SD4 indicate two strokes constituting the handwritten character “B”. The fifth piece of stroke data SD5 indicates the stroke constituting the handwritten character “C”. The sixth and seventh pieces of stroke data SD6 and SD7 indicate two strokes constituting the handwritten “arrow”.

Each piece of stroke data contains the coordinate data series (the times-series coordinates) corresponding to the stroke, namely, plural coordinates corresponding to the plural points on the locus of the stroke. In each piece of stroke data, the coordinates are arranged in time series in the order in which the stroke is written. For example, as to the handwritten character “A”, the stroke data SD1 contains the coordinate data series (the time series coordinates) corresponding to the points on the locus of the stroke having the “ [symbol] ” shape, namely, n pieces of coordinate data SD11, SD12, . . . , SD1n. The stroke data SD2 contains the coordinate data series corresponding to the points on the locus of the stroke having the “-” shape in the handwritten character “A”, namely, n pieces of coordinate data SD21, SD22, . . . , SD2n. The number of pieces of coordinate data may vary according to the stroke data.

Each piece of coordinate data indicates an X coordinate and a Y coordinate corresponding to a point existing in the corresponding locus. For example, the coordinate data SD11 indicates an X coordinate (X11) and a Y coordinate (Y11) at a starting point of the stroke having the “ [symbol] ” shape. The coordinate data SD1n indicates an X coordinate (X1n) and a Y coordinate (Y1n) at an ending point of the stroke having the “ [symbol] ” shape.

Each piece of coordinate data may contain time stamp information T corresponding to a time point when the point corresponding to the coordinate is handwritten. The time point of the handwriting may be an absolute time (for example, year, month, day, hour, minute, and second) or a relative time based on a certain time point. For example, the absolute time (for example, year, month, day, hour, minute, and second) when the stroke is started to be written may be added to each piece of stroke data as the time stamp information, and the relative time indicating a difference from the absolute time may be added to each piece of coordinate data in the stroke data as the time stamp information T.

Thus, a temporal relationship between strokes can precisely be expressed using the time-series information in which the time stamp information T is added to each piece of coordinate data.

Additionally, information (Z) indicating a writing pressure may be added to each piece of coordinate data.

The time-series information 200 having the structure in FIG. 3 can express not only the handwriting of each stroke but also the temporal relationship between strokes. Accordingly, the use of the time-series information 200 can deal with the handwritten character “A” and a front end portion of the handwritten “arrow” as different characters or different figures, even if the front end portion of the handwritten “arrow” is written while overlapping with or being close to the handwritten character “A” as illustrated in FIG. 2.

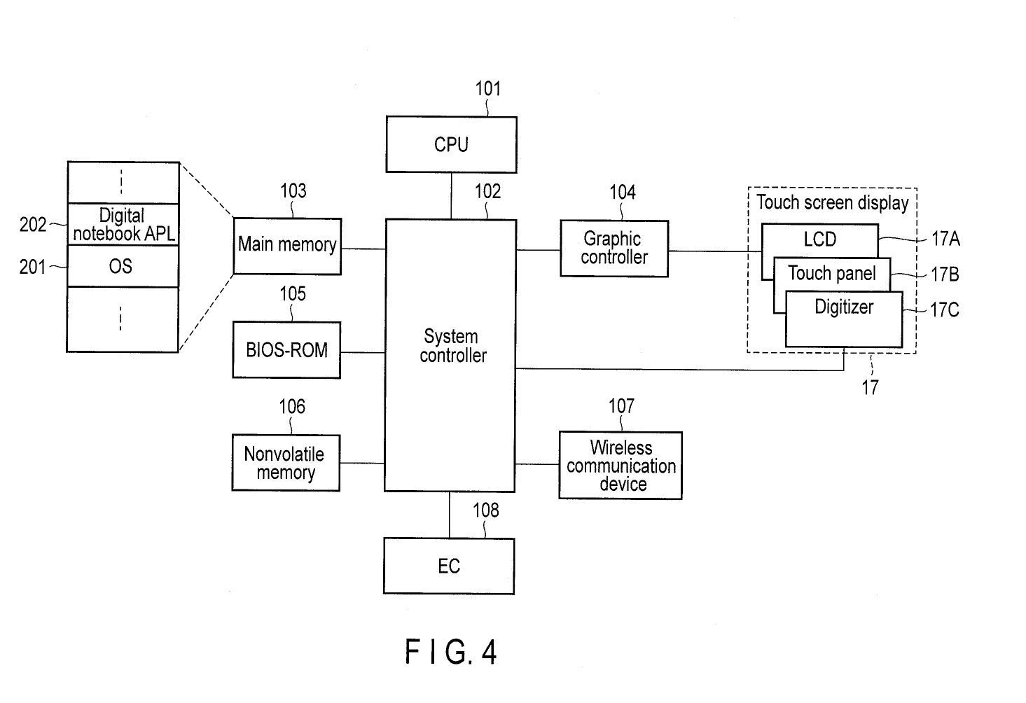

FIG. 4 is a view illustrating a system configuration of the tablet computer 10.

As illustrated in FIG. 4, the tablet computer 10 includes a CPU 101, a system controller 102, a main memory 103, a graphic controller 104, a BIOS-ROM 105, a nonvolatile memory 106, a wireless communication device 107, and an embedded controller (EC) 108.

The CPU 101 is a processor that controls operations of various modules in the tablet computer 10. The CPU 101 executes various pieces of software loaded onto the main memory 103 from the nonvolatile memory 106 that is of the storage device. The pieces of software include an operating system (OS) 201 and various application programs. A digital notebook application program 202 is included in the application programs. The digital notebook application program 202 has a function of producing and displaying the handwritten document and a function of editing the handwritten document, and a function of recognizing the character and the figure.

The CPU 101 executes a basic input/output system (BIOS) stored in the BIOS-ROM 105. The BIOS is a program that controls hardware.

The system controller 102 is a device that connects a local bus of the CPU 101 and various components. The system controller 102 is provided with a memory controller that controls access to the main memory 103. The system controller 102 also has a function of conducting communication with the graphic controller 104 through a serial bus compatible with a PCI EXPRESS standard.

The graphic controller 104 is a display controller that controls an LCD 17A used as a display monitor of the tablet computer 10. A display signal generated by the graphic controller 104 is transmitted to the LCD 17A. The LCD 17A displays a screen image based on the display signal. A touch panel 17B and a digitizer 17C are arranged on the LCD 17A. The touch panel 17B is a capacitance type pointing device that performs input on the screen of the LCD 17A. The touch panel 17B detects the contact position on the screen with which the finger comes into contact and the movement of the contact position. The digitizer 17C outputs the coordinate indicating the contact position on the screen. The digitizer 17C is an electromagnetic induction type pointing device that performs the input on the screen of the LCD 17A. The digitizer 17C detects the contact position on the screen with which the pen 100 comes into contact and the movement of the contact position. The digitizer 17C outputs the coordinate indicating the position of the pen 100 on the screen.

The wireless communication device 107 is configured to conduct wireless communication, such as wireless LAN and 3G mobile communication. The EC 108 is a one-chip microcomputer that includes an embedded controller for power management. The EC 108 has a function of turning on and off the power of the tablet computer 10 in response to a power button operation performed by the user.

A functional configuration of the digital notebook application program 202 will be described below with reference to FIG. 5.

The digital notebook application program 202 includes a mode controller 301, a time-series information generator 302, a handwritten document drawing processor 303, a display processor 304, a page storage processor 305, a page acquisition processor 306, and a deletion processor 307.

The digital notebook application program 202 produces, displays, and edits the handwritten document by the use of the stroke data that is input with the touch screen display 17. The touch screen display 17 is configured to detect an occurrence of events, such as “touch”, “movement (slide)”, and “release”. The “touch” is an event indicating that an external object comes into contact with the screen. The “movement (slide)” is an event indicating that the contact position moves while the external object is in contact with the screen. The “release” is an event indicating that the external object is released from the screen.

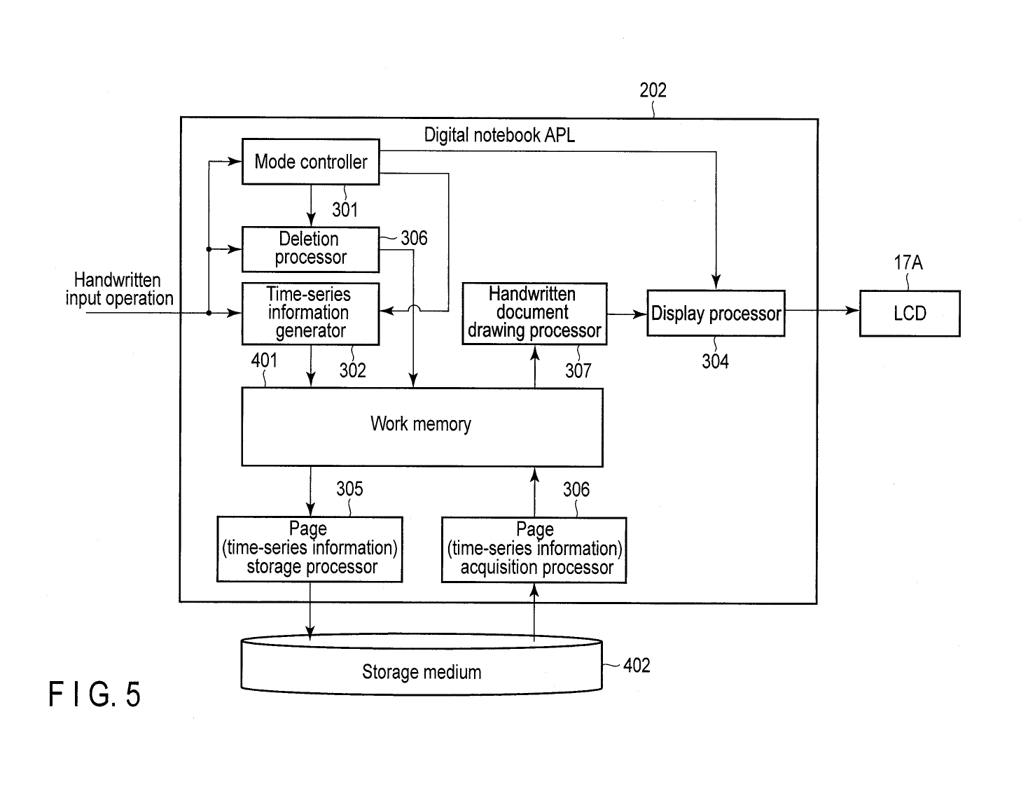

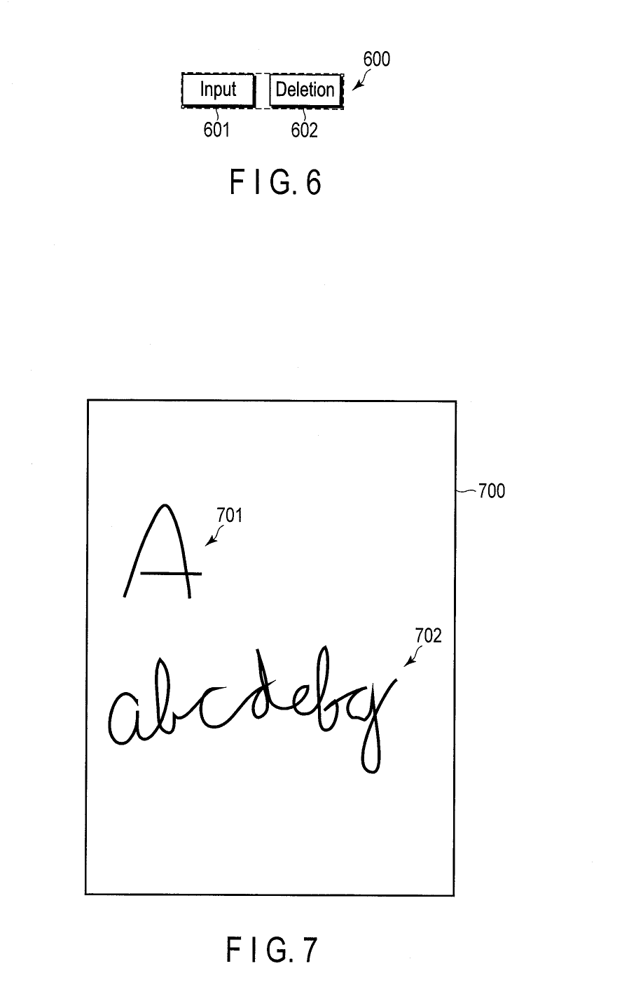

The mode controller 301 performs processing of drawing an interface including an input mode button and a deletion mode button, which are used to switch between an input mode and a deletion mode. The drawn interface is transmitted to the display processor 304. FIG. 6 is a view illustrating an example of the interface. An interface 600 includes an input mode button 601 and a deletion mode button 602. When the pen or the finger touches on the input mode button 601, the input mode is obtained. When the pen or the finger touches on the deletion mode button 602, the deletion mode is obtained. When the pen or the finger touches on the input mode button 601, the mode controller 301 notifies the time-series information generator 302 and the deletion processor 307 of the input mode. When the pen or the finger touches on the deletion mode button 602, the mode controller 301 notifies the time-series information generator 302 and the deletion processor 307 of the deletion mode.

The time-series information generator 302 receive the event of “touch” or “movement (slide)” generated by the touch screen display 17, thereby detecting a handwritten input operation. The “touch” event includes the coordinate of the contact position. The “movement (slide)” event includes the coordinate of the destination contact position. Accordingly, the time-series information generator 302 can receive the coordinate series corresponding to the locus of the movement of the contact position from the touch screen display 17.

The time-series information generator 302 receives the coordinate series output from the touch screen display 17, and generates the time-series information based on the coordinate series. The time-series information generator 302 may temporarily store the time-series information, namely, the coordinate data and the time stamp information, which correspond to each point of the stroke in a work memory 401.

The handwritten document drawing processor 303 analyzes the time-series information in the work memory 401, and performs processing of drawing the locus of each stroke indicated by the time-series information as the handwritten page based on the analysis result. The handwritten document drawing processor 303 draws the locus of the pen 100, namely, the locus of each stroke on the handwritten page while the pen 100 is in contact with the screen.

FIG. 7 is a view illustrating an example of a handwritten page 700 drawn by the handwritten document drawing processor 303. As illustrated in FIG. 7, a block handwritten character “A” 701 and cursive handwritten characters “a b c d e f g” 702 are drawn in the handwritten page 700.

The display processor 304 draws the interface 600, which is drawn by the mode controller 301 on the handwritten page drawn by the handwritten document drawing processor 303, and performs processing of generating data, which is used to display the handwritten document including the interface 600 on the LCD 17A.

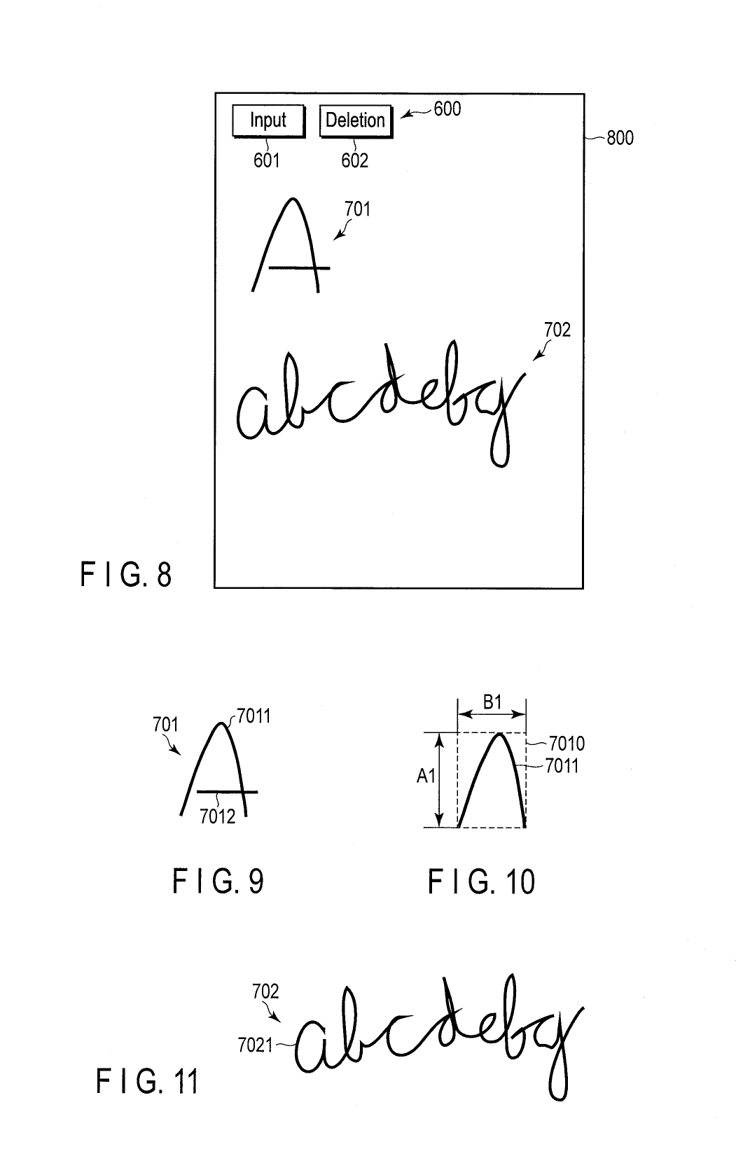

FIG. 8 is a view illustrating an example of the handwritten page displayed on the LCD 17A. As illustrated in FIG. 8, the handwritten character “A” 701, the cursive handwritten characters “a b c d e f g” 702, and the interface 600 are displayed in a handwritten page 800.

The page storage processor 305 stores the generated time-series information in a storage medium 402 as the handwritten document (the handwritten page). As described above, the storage medium 402 may be one of the storage device of the tablet computer 10, the storage device of the tablet computer 10, and the storage device of the server.

The page acquisition processor 306 reads any piece of time-series information stored in the storage medium 402. The read time-series information is stored in the work memory 401. The handwritten document drawing processor 303 analyzes the time-series information, and displays the locus of each stroke indicated by the time-series information as the handwritten page on the screen.

The time-series information generator 302 includes the deletion processor 307. In the deletion mode, the deletion processor 307 performs processing of deleting part or a whole of the locus selected by the touch of the pen. In order to perform the processing of deleting the part or the whole of the locus selected by the touch of the pen, the deletion processor 307 performs processing of deleting at least part or the whole of the stroke data corresponding to the touched locus based on a vertical width and a horizontal width of the selected locus. More specifically, the part or the whole of the stroke data corresponding to the touched locus is deleted based on a ratio of the vertical width and the horizontal width of a circumscribed figure (circumscribed frames, such as a circumscribed rectangle) of the selected locus.

The cursive alphabetical characters are written by a one-stroke successive character. In this case, when the cursive alphabetical characters are deleted in a stroke unit, the whole successive character is deleted, and inconveniently the number of characters increases when the deleted successive character is rewritten. Frequently Japanese characters or block alphabetical characters are conveniently deleted in a stroke unit. The deletion processor 307 deletes the handwritten characters in a locus unit or part of the locus based on the ratio of the vertical width and the horizontal width of the circumscribed figure of the selected locus.

FIG. 9 is a view illustrating the handwritten character “A” 701. The handwritten character “A” 701 includes a locus 7011 and a locus 7012. FIG. 10 is a view illustrating the locus 7011 of the handwritten character “A” 701. For example, a ratio of a vertical width A1 and a horizontal width B1 of a circumscribed FIG. 7010 of the locus 7011 is A1/B1.

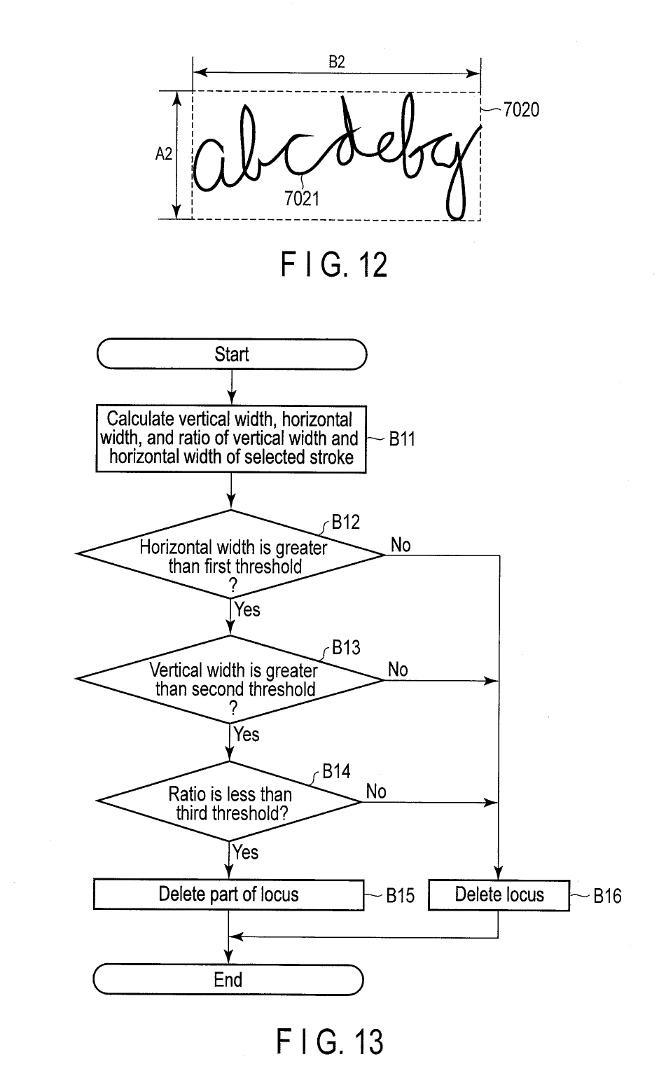

FIG. 11 is a view illustrating the handwritten characters “a b c d e f g” 702. The handwritten characters “a b c d e f g” 702 includes a locus 7021. FIG. 12 is a view illustrating the locus 7021. A ratio of a vertical width A2 and a horizontal width B2 of a circumscribed FIG. 7020 of the locus 7021 is A2/B2.

Because the cursive handwritten characters “a b c d e f g” 702 is horizontally long, the ratio A2/B2 of the vertical width A2 and the horizontal width B2 of the circumscribed figure of the handwritten characters “a b c d e f g” 702 tends to be less than the ratio A1/B1 of the vertical width A1 and the horizontal width B1 of the circumscribed figure of the locus 7011.

The deletion processor 307 performs the processing of deleting the part of the selected locus when a ratio A/B of a vertical width A and a horizontal width B of the circumscribed figure of the selected locus is less than a threshold. In order to delete the part of the selected locus, the deletion processor 307 deletes the part of the stroke data in the time-series information corresponding to the selected locus. More specifically, based on the time stamp information T, the deletion processor 307 deletes the pieces of coordinate data corresponding to the locus, which is input after the assigned point on the locus, from the stroke data corresponding to the selected locus in the time-series information when the point is assigned on the locus.

The deletion processor 307 performs the processing of deleting the whole of the selected locus when the ratio A/B of the vertical width A and the horizontal width B of the circumscribed figure of the selected locus is greater than or equal to the threshold. More specifically, the deletion processor 307 deletes the stroke data corresponding to the selected locus in the time-series information.

When the locus 7012 is selected, the ratio of the vertical width and the horizontal width of the circumscribed figure of the shape “-” decreases because the shape “-” is horizontally long. For this reason, part of the shape “-” is deleted even if the shape “-” is handwritten in the block character. Therefore, whether the horizontal width of the selected locus is greater than the threshold is determined before the ratio of the vertical width and the horizontal width is compared to the threshold, and whether the vertical width of the selected locus is greater than the threshold may be determined. When the horizontal width is determined to be greater than the threshold while the vertical width is determined to be less than or equal to the threshold, the selected locus may be deleted. In the case that the vertical width is determined to be less than or equal to the threshold, the selected locus may be deleted because the selected locus is assumed to be a horizontal line.

FIG. 13 is a flowchart illustrating procedure of the deletion processing performed by the deletion processor 307 in the deletion mode.

The deletion processor 307 calculates the vertical width, the horizontal width, and the ratio (vertical width/horizontal width) of the vertical width and the horizontal width of the selected locus (Block B11). The horizontal width is calculated based on a difference between a maximum coordinate value and a minimum coordinate value in the horizontal direction of the stroke data corresponding to the selected locus. The vertical width is calculated based on a difference between a maximum coordinate value and a minimum coordinate value in the vertical direction of the stroke data corresponding to the selected locus. The ratio (vertical width/horizontal width) of the vertical width and the horizontal width is calculated based on the calculated vertical width and horizontal width.

The deletion processor 307 determines whether the horizontal width is greater than a first threshold (Block B12). When determining that the horizontal width is greater than the first threshold (Yes in Block B12), the deletion processor 307 determines whether the vertical width is greater than a second threshold (Block B13). When determining that the vertical width is greater than the second threshold (Yes in Block B13), the deletion processor 307 determines whether the ratio of the vertical width and the horizontal width is less than a third threshold (Block B14). When determining that the ratio is less than the third threshold (Yes in Block B14), the deletion processor 307 deletes the part of the stroke data corresponding to the locus (Block B15).

When determining that the horizontal width is less than or equal to the first threshold (No in Block B12), when determining that the vertical width is less than or equal to the second threshold (No in Block B13), and when determining that the ratio is greater than or equal to the third threshold (No in Block B14), the deletion processor 307 deletes the whole stroke data corresponding to the selected locus (Block B16).

For the vertical line of the figure or character, the negative determination (No) is made in Block B12 and the deletion is performed in a stroke unit. For the horizontal line of the figure or character, the negative determination (No) is made in Block B13 and the deletion is performed in a locus unit. For the cursive alphabetic character, the affirmative determination (Yes) is made in Block B14 and the part of the locus is deleted. The negative determination (No) is made for the locus constituting the block character, and the deletion is performed in a locus unit.

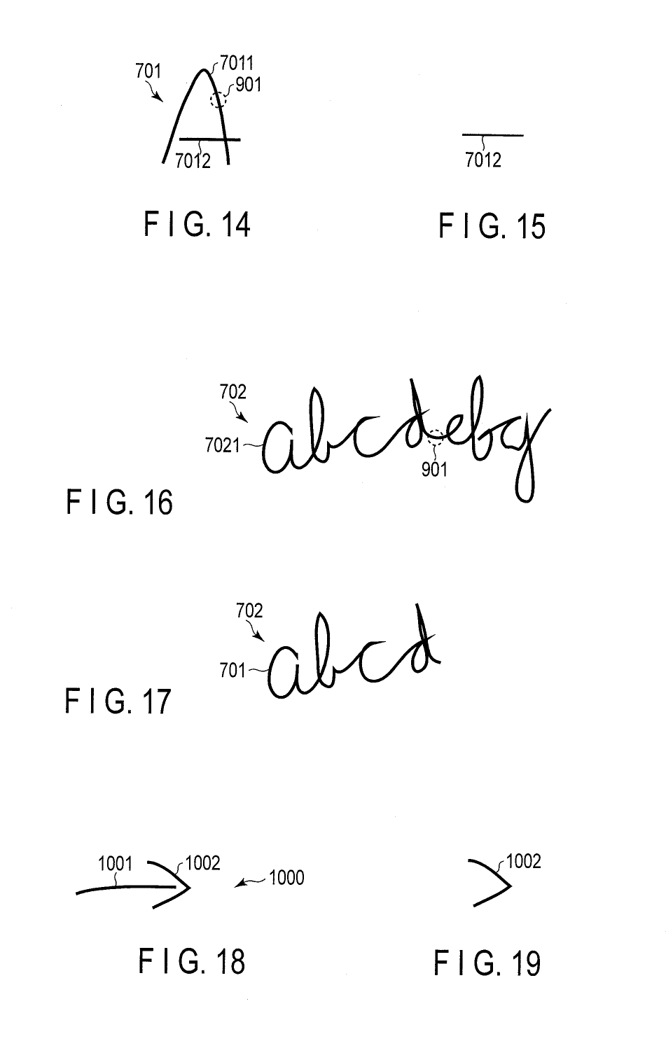

For example, the case that the pen 100 touches on the locus 7011 to select the locus 7011 in the locus 7011 and the locus 7012 of the block handwritten character “A” 701 as illustrated in FIG. 14 will be described below. A pointer 901 indicates the touch position of the pen 100. In this case, the negative determination (No) is made in Block B14 and the deletion is performed in a unit of the locus 7011. That is, as illustrated in FIG. 15, the selected locus 7011 is deleted and only the locus 7012 is displayed.

For example, the case that the pen touches on the locus 7021 of the successive alphabetical characters “a b c d e f g” handwritten in the cursive writing to assign the point on the locus 7021 as illustrated in FIG. 16 will be described below. In this case, the affirmative determination (Yes) is made in Block B14 and the part of the locus is deleted. That is, the locus, which is input after the assigned point on the locus, is deleted as illustrated in FIG. 17.

FIGS. 18 and 19 are views illustrating an example of the deletion. As illustrated in FIG. 18, an arrow 1000 includes a locus 1001 and a locus 1002. The locus 1001 that is of the horizontal line of the arrow 1000 is selected. In this case, the negative determination (No) is made in Block B13. Therefore, as illustrated in FIG. 19, the deletion is performed in a unit of the locus 1001 and only the locus 1002 is displayed.

At least the part of the selected locus is deleted according to the ratio of the vertical width and the horizontal width of the selected locus, so that the handwritten locus displayed on the display can efficiently be deleted.

Various kinds of processing on a handwritten document according to the embodiment can be realized by a computer program and thus, the same effect as that in the embodiment can easily be realized only by installing the computer program through a computer readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic device comprising:
a display controller configured to display a locus corresponding to a stroke; and
a processor configured to perform one of processing of deleting a part of a first locus or processing of deleting all of the first locus, based on a vertical width and a horizontal width which correspond to the first locus,
wherein the processor is configured to perform the processing of deleting all of the first locus if a ratio of the vertical width to the horizontal width is less than a first threshold or the horizontal width is less than a second threshold.

2. (canceled)

3. The device of claim 1, wherein the processor is configured to delete a portion that is input by handwriting after a first point if the first point on the first locus is selected and the ratio is less than the first threshold.

4. (canceled)

5. The device of claim 1, wherein the processor is configured to perform the processing of deleting at least the part when the horizontal width is greater than the second threshold and the vertical width is not greater than a third threshold.

6. A handwritten document processing method comprising:
displaying a locus corresponding to a stroke; and
performing one of processing of deleting a part of a first locus or processing of deleting all of the first locus, based on a vertical width and a horizontal width which correspond to the first locus,
wherein the processor is configured to perform the processing of deleting all of the first locus if a ratio of the vertical width to the horizontal width is less than a first threshold or the horizontal width is less than a second threshold.

7. A computer-readable, non-transitory storage medium configured to store a computer program which is executable by a computer, the computer program controlling the computer to execute functions of:
displaying a locus corresponding to a stroke; and
performing one of processing of deleting a part of a first locus or processing of deleting all of the first locus based on a vertical width and a horizontal width, which correspond to the first locus,
wherein the processor is configured to perform the processing of deleting all of the first locus if a ratio of the vertical width to the horizontal width is less than a first threshold or the horizontal width is less than a second threshold.

8. The method of claim 6, wherein the performing comprises deleting a portion that is input by handwriting after a first point if the first point on the first locus is selected and the ratio is less than the first threshold.

9. The method of claim 6, wherein the processing of deleting at least the part is performing when the horizontal width is greater than the second threshold and the vertical width is not greater than a third threshold.

10. The medium of claim 7, wherein the performing comprises deleting a portion that is input by handwriting after a first point if the first point on the first locus is selected and the ratio is less than the first threshold.

11. The medium of claim 7, wherein the processing of deleting at least the part is performing when the horizontal width is greater than the second threshold and the vertical width is not greater than a third threshold.
